(19) United States
(12) Patent Application Publication
(10) Pub. No.: US 2024/0262640 A1
(43) Pub. Date: Aug. 8, 2024

(54) SUSTAINABLE ON-DEMAND MICRO SPACE VERTICAL COLD CHAIN TEMPERATURE-CONTROLLED STORAGE WITH BIDIRECTIONAL GRAVITY HELD SHELF PLACEMENT AND RETRIEVAL

(71) Applicant: Phononic, Inc., Durham, NC (US)

(72) Inventor: Dana Krug, Lenexa, KS (US)

(21) Appl. No.: 18/432,616

(22) Filed: Feb. 5, 2024

Related U.S. Application Data
(60) Provisional application No. 63/443,172, filed on Feb. 3, 2023.

(51) Int. Cl. B65G 67/20; F25D 11/00

(52) U.S. Cl. CPC B65G 67/20; B65G 2201/0235; F25D 11/003

(57) ABSTRACT

Vertical cold chain temperature-controlled storage and methods of operating the same are provided. In some embodiments, a vertical cold chain temperature-controlled storage system includes: a vertical lift module which includes: a plurality of shelves; and at least one opening. One or more of the plurality of shelves includes a power subsystem for powering a tote. This might enable more efficient and more dynamic temperature control during storage.

### RELATED APPLICATIONS

This application claims the benefit of provisional patent application Ser. No. 63/443,172, filed Feb. 3, 2023, the disclosure of which is hereby incorporated herein by reference in its entirety.

### FIELD OF THE DISCLOSURE

The disclosure relates generally to temperature-controlled environments.

### BACKGROUND

Cold chain transport for food, drug or any products that need temperature control for delivery currently is done with tri temperature or refer trucks and vans upfitted with compressor based systems that cool or freeze the entire sectioned area of a truck and must be run constantly to maintain temperature inside the truck. Whether the truck has one gallon of milk or a pint of ice cream, the entire space must be cooled or frozen. Compressor based refer trucks and tri temp trucks or vans must be penetrated from the outside to get the cooling platform of a compressor-based system inside the truck or van, which voids the warranty of the van or truck. In addition, to run tri temperature trucks, dividers must exist between the temperature zones to maintain temperature. The separation of space requires separation of orders that have goods in two or more zones. Compressor based systems pull too much power for the system to be placed in or on a fully electric vehicle without degrading the range of the vehicle significantly

Improved systems and methods for thermal management are needed.

### SUMMARY

Vertical cold chain temperature-controlled storage and methods of operating the same are provided. In some embodiments, a vertical cold chain temperature-controlled storage system includes: a vertical lift module which includes: a plurality of shelves; and at least one opening. One or more of the plurality of shelves includes a power subsystem for powering a tote. This might enable more efficient and more dynamic temperature control during storage.

In some embodiments, the power subsystem comprises power contacts at the bottom of the shelves.

In some embodiments, the power subsystem comprises a wireless power system.

In some embodiments, one or more of the plurality of shelves comprises a locking mechanism for securing a tote.

In some embodiments, the system also includes a communication module. In some embodiments, the communication module enables control of on demand cooling for one or more of the plurality of shelves.

In some embodiments, the system also includes at least two openings in the vertical lift module. In some embodiments, the at least two openings in the vertical lift module enable a tote to be placed on or off the shelf from both directions.

In some embodiments, the vertical cold chain temperature-controlled storage system is in an ambient environment.

In some embodiments, the vertical lift module can rotate the plurality of shelves to align one or more of the plurality of shelves with the at least one opening.

In some embodiments, a method of operating a vertical cold chain temperature-controlled storage system, includes: providing, via a power subsystem, power a tote on one or more of a plurality of shelves. The vertical cold chain temperature-controlled storage system includes: a vertical lift module including: a plurality of shelves; and at least one opening.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A-1D illustrate utilization of a portable, self-contained, refrigeration or freezing system, coupled with integrated automated controls and monitoring;

FIG. 2 and FIGS. 3A and 3B illustrate an example embodiment of an active cooler in accordance with embodiments of the present disclosure;

FIG. 4 illustrates a system including an active cooler in accordance with some embodiments of the present disclosure;

FIG. 5 illustrates an example of a tote as discussed herein;

FIGS. 6A and 6B illustrate that different versions of the totes could be used in refrigerator or freezer versions;

FIG. 7 shows an exploded view of the tote that includes a thermoelectric unit as discussed herein;

FIG. 8 shows the standard tri-temperature truck that is used for deliveries;

FIG. 9 illustrates a delivery truck which does not need refrigeration systems or needs less;

FIG. 10 illustrates a vertical storage system that must have an entire enclosure of the entire vertical storage unit by temperature zone to cool or freeze items in vertical storage;

FIG. 11 illustrates a vertical cold chain temperature-controlled storage unit, according to some embodiments of the present disclosure; and

FIG. 12 illustrates a single shelf consolidated storage unit, according to some embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Last mile delivery of food requires temperature-controlled transport of perishable food items using transit vans or similar vehicles. For temperature control, refrigerated or freezer totes can be used which are installed in the van (e.g., a cargo van) or a box truck.

These totes use an active heat pump to pull heat from an enclosed chamber and reject it to surrounding ambient air. The hot air must be removed from the van to ensure optimum operation of the totes.

These totes require power while in transit maintain food safety requirements for perishable consumption. The electrical system needs to reach (and/or maintain) the correct temperature must be met for operation of the totes.

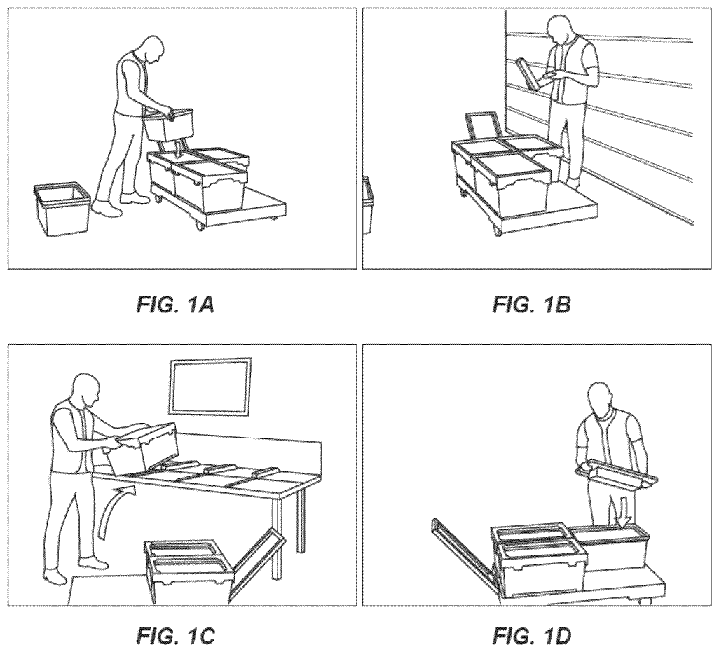

FIGS. 1A-1D illustrate utilization of a portable, self-contained, refrigeration or freezing system, coupled with integrated automated controls and monitoring.

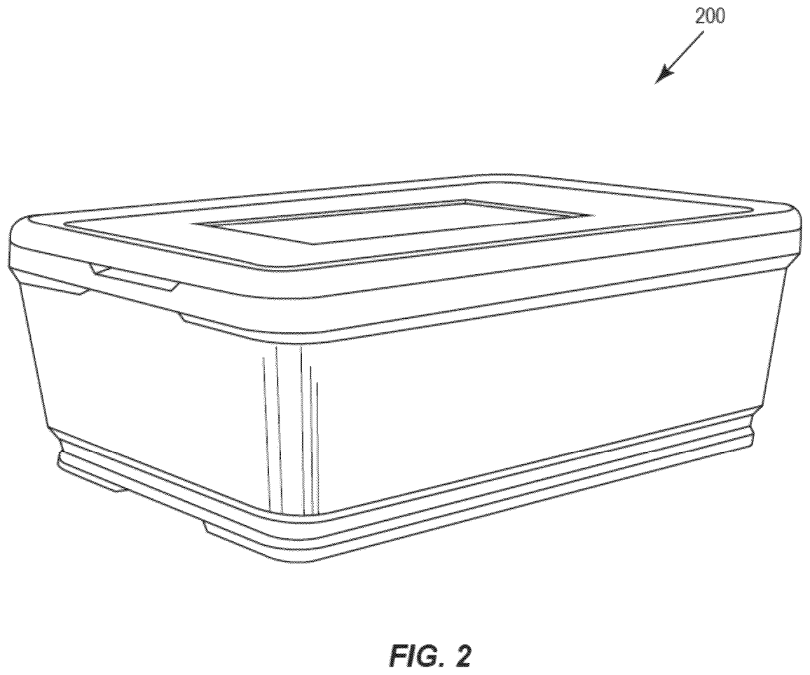

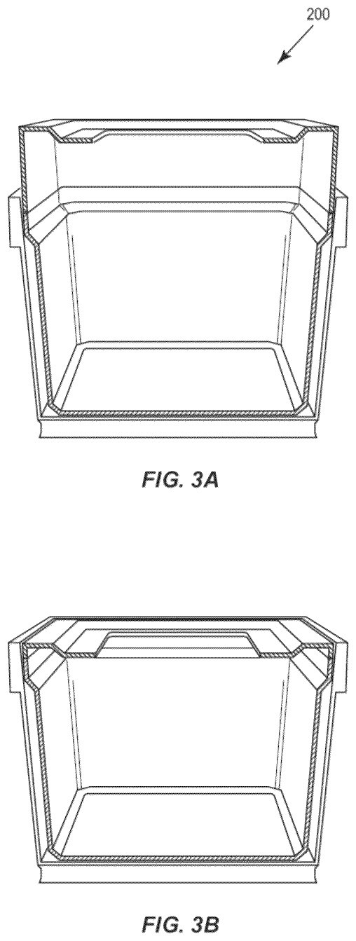

FIG. 2 and FIGS. 3A and 3B illustrate an example embodiment of an active cooler in accordance with embodiments of the present disclosure.

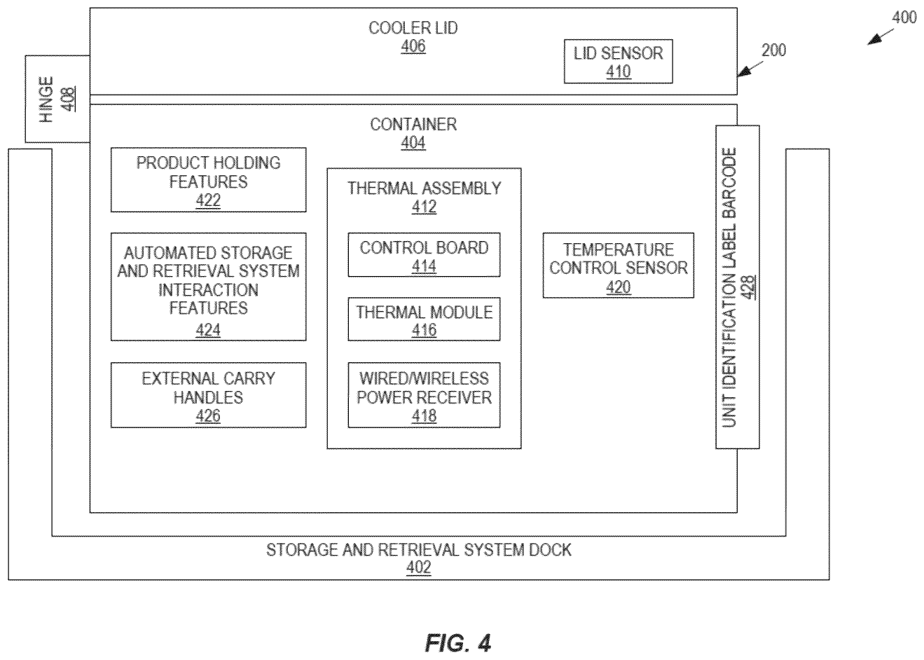

FIG. 4 illustrates a system including an active cooler in accordance with some embodiments of the present disclosure.

For more details, the interested reader is directed to U.S. Provisional Patent Application Ser. No. 62/953,771, entitled THERMOELECTRIC REFRIGERATED/FROZEN PRODUCT STORAGE AND TRANSPORTATION COOLER; U.S. patent application Ser. No. 17/135,420, entitled THERMOELECTRIC REFRIGERATED/FROZEN PRODUCT STORAGE AND TRANSPORTATION COOLER, now U.S. Patent Application Publication No. 2021/0199353 A1; and International Patent Application No. PCT/US2020/067172, entitled THERMOELECTRIC REFRIGERATED/FROZEN PRODUCT STORAGE AND TRANSPORTATION COOLER, now International Patent Publication No. WO 2021/134068. These applications are hereby incorporated herein by reference in their entirety.

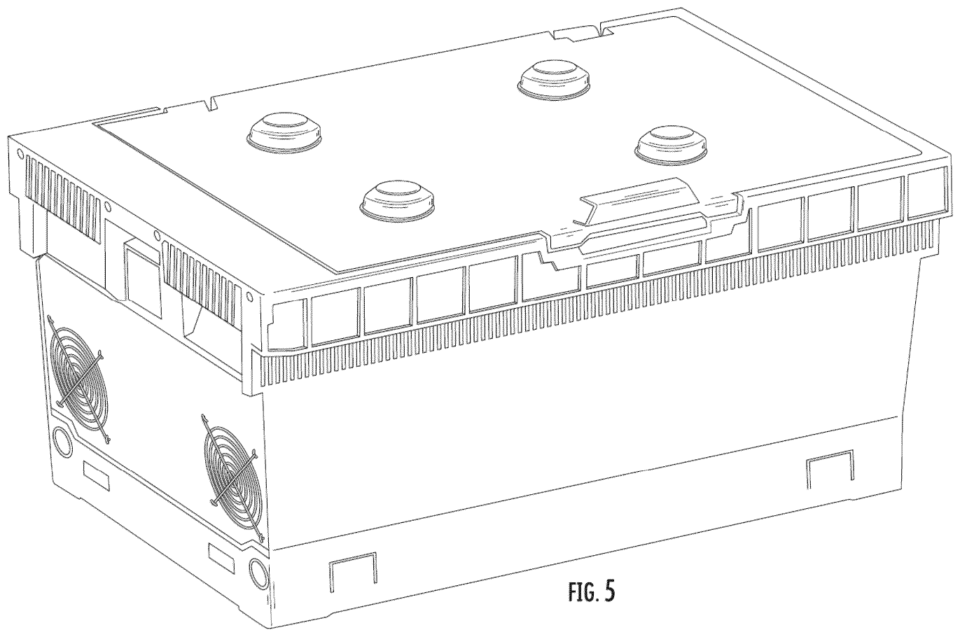

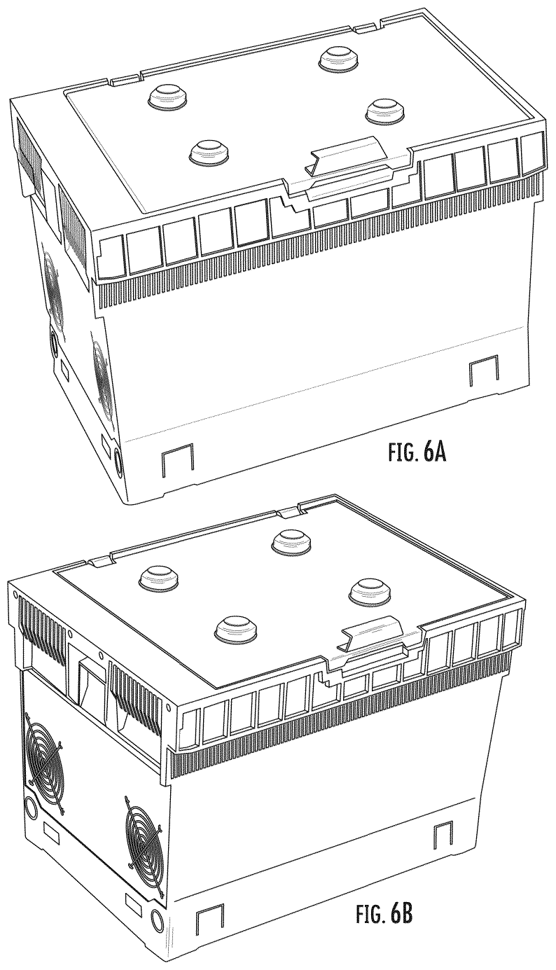

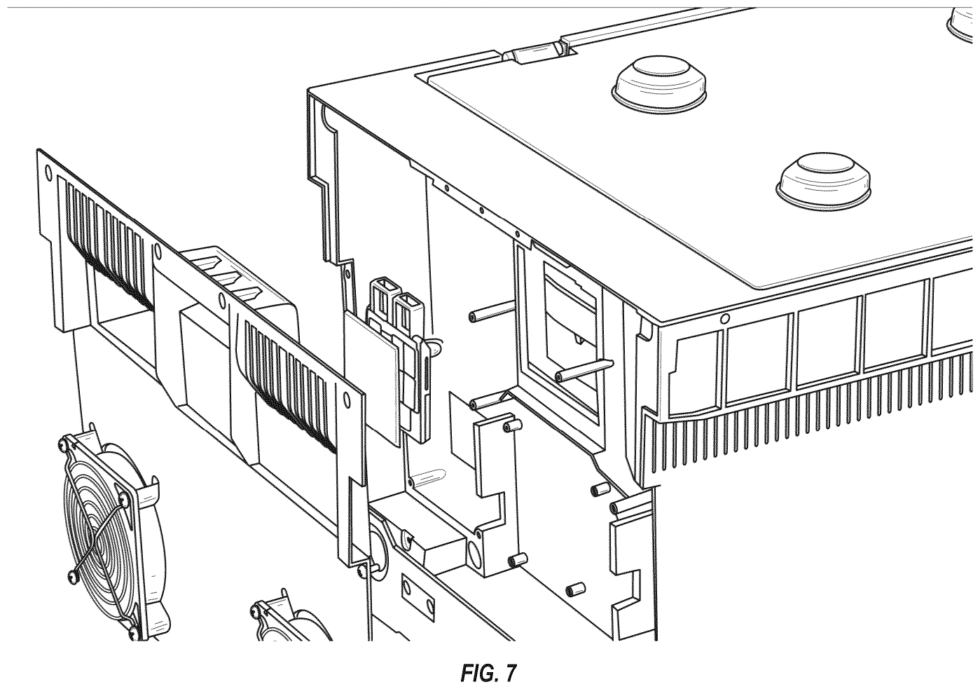

FIG. 5 illustrates an example of a tote as discussed herein. FIGS. 6A and 6B illustrate that different versions of the totes could be used in refrigerator or freezer versions. FIG. 7 shows an exploded view of the tote that includes a thermoelectric unit as discussed herein.

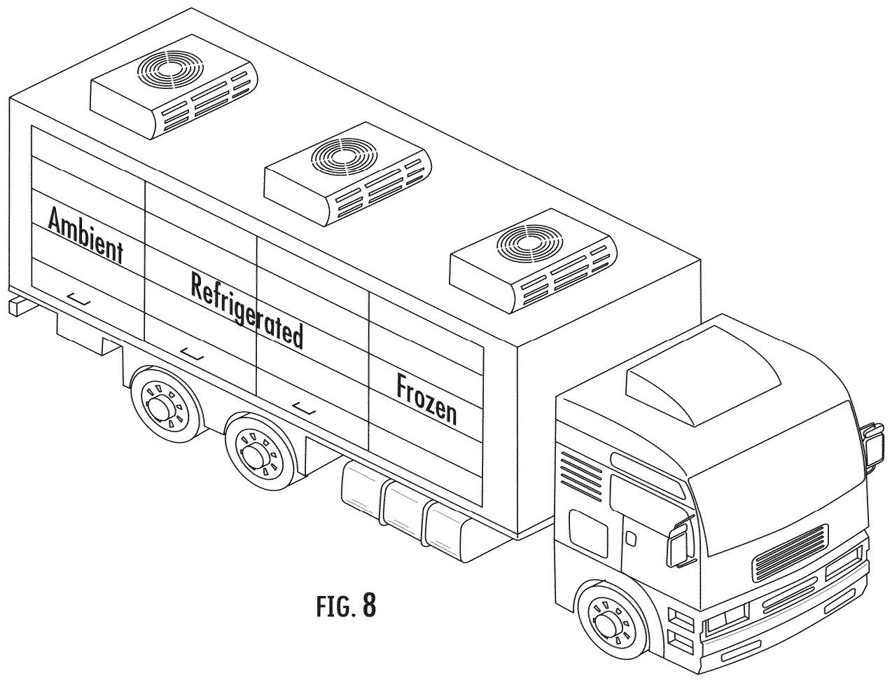

FIG. 8 shows the standard tri-temperature truck that is used for deliveries. This might include several different cooling systems that must be carried around regardless of whether they are currently needed.

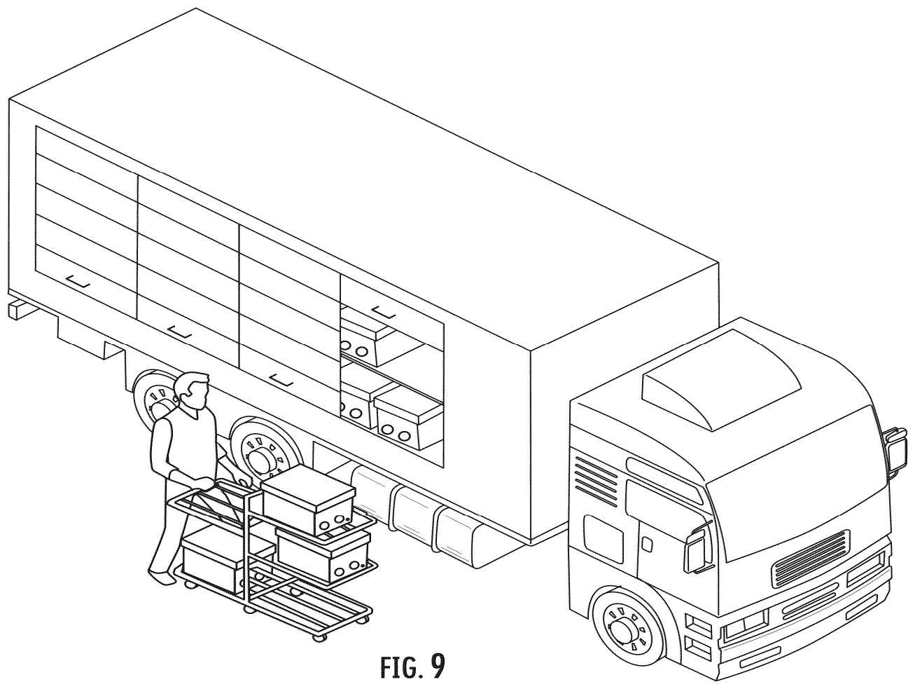

FIG. 9 illustrates a delivery truck which does not need refrigeration systems or needs less. In this embodiment, the totes provide the proper temperatures for the various goods. This can make the trucks more efficient in many ways. This also adds configurability. If an entire truck is needed for a specific temperature, this can be easily accomplished as opposed to the standard truck. These trucks might include charging capabilities or other amenities.

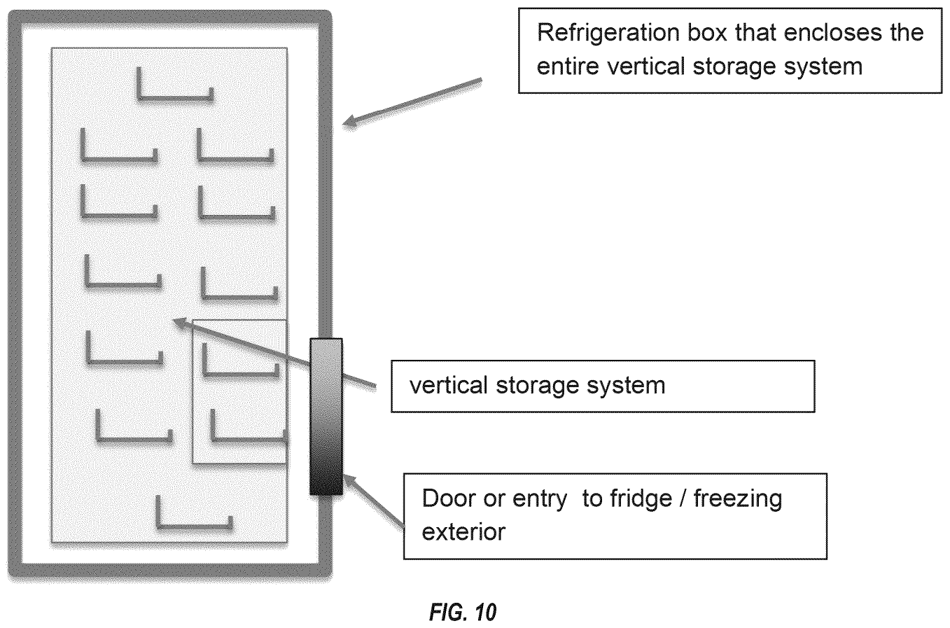

Current vertical storage systems must have an entire enclosure of the entire vertical storage unit by temperature zone to cool or freeze items in vertical storage. An example of this is shown in FIG. 10.

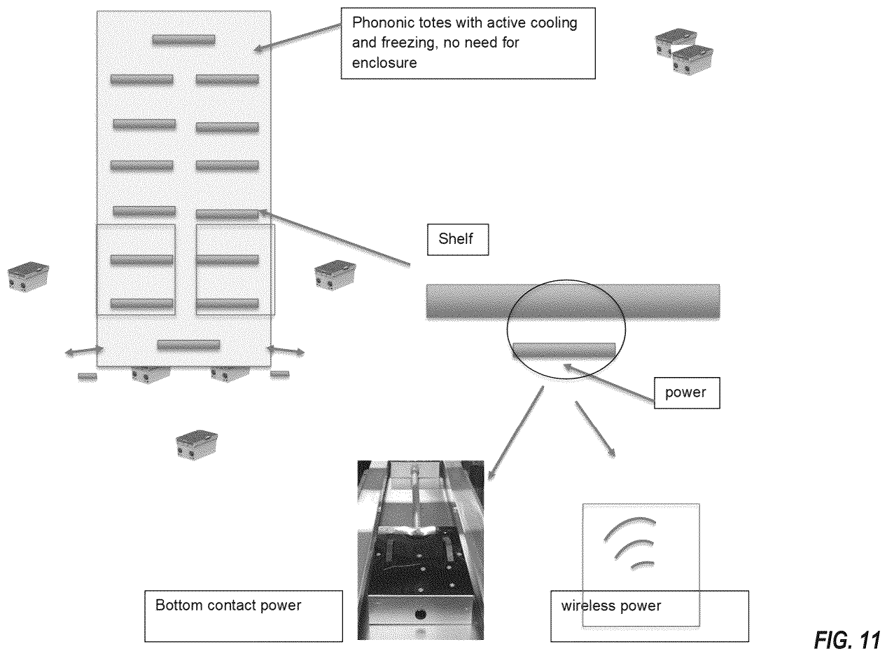

In some embodiments, power contacts can be placed at the bottom of a shelving or wireless power can be placed in a vertical storage unit (carousel or vertical lift module (VLM)), and totes can be used as micro space for the temperature control for each item or order. On demand cooling by item can be provided, and items can be placed in a vertical storage system that reduces energy using IOT control with on demand cooling and with wireless contacts or power contacts at the bottom of the shelf because there is no longer an obstacle that prevents the totes from being placed on or off the shelf from both directions. This allows for removal and placement of the tote in a vertical system from both sides of the lift. An example of this is shown in FIG. 11.

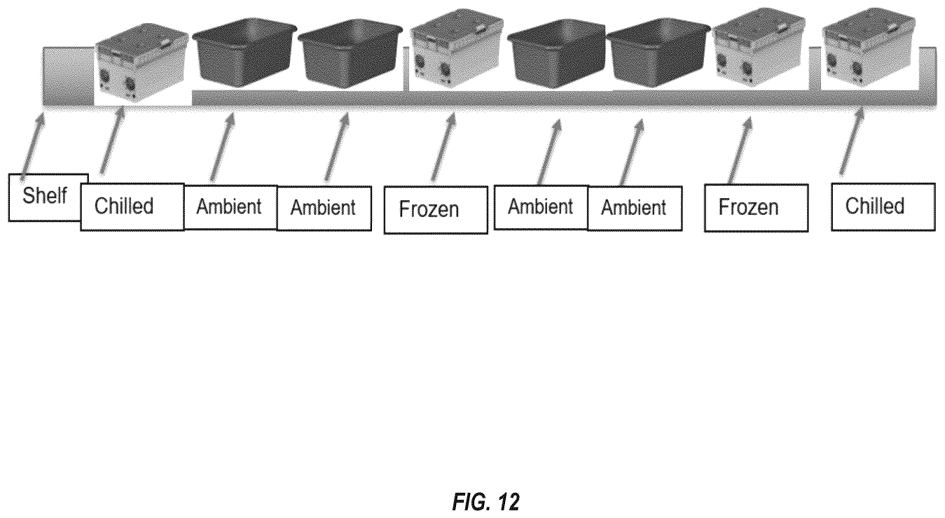

In some embodiments, there is a single shelf of consolidated storage for each order no matter the temperature needed by item. An example of this is shown in FIG. 12. In some embodiments, totes provide the micro temperature control of items at any temperature from −20 C to higher temperatures (can even include heating). In some embodiments, no cooling enclosure is needed for the vertical storage system. In some embodiments, bottom contacts provide power to totes. In some embodiments, wireless charging can provide power to totes. In some embodiments, the tote weight and gravity hold the tote against the power contact. In some embodiments, there are no obstacles on either side of shelf, which allows for access from both sides of the shelf. In some embodiments, access to both sides of the shelf allows access from both sides of the vertical system so you can retrieve or place totes on the shelf from both sides. In some embodiments, IOT monitors the totes for health, temperature and allows for command and control of totes for power and on-demand cooling. In some embodiments, totes using CO₂ and water as refrigerant provide sustainable cooling.

Those skilled in the art will recognize improvements and modifications to the preferred embodiments of the present disclosure. All such improvements and modifications are considered within the scope of the concepts disclosed herein and the claims that follow.

1. A vertical cold chain temperature-controlled storage system, comprising:
a vertical lift module comprising:
a plurality of shelves; and
at least one opening;
wherein one or more of the plurality of shelves comprises a power subsystem for powering a tote.

2. The vertical cold chain temperature-controlled storage system of claim 1 wherein the power subsystem comprises power contacts at the bottom of the shelves.

3. The vertical cold chain temperature-controlled storage system of claim 1 wherein the power subsystem comprises a wireless power system.

4. The vertical cold chain temperature-controlled storage system of claim 1 wherein one or more of the plurality of shelves comprises a locking mechanism for securing a tote.

5. The vertical cold chain temperature-controlled storage system of claim 1 further comprising a communication module.

6. The vertical cold chain temperature-controlled storage system of claim 5 wherein the communication module enables control of on demand cooling for one or more of the plurality of shelves.

7. The vertical cold chain temperature-controlled storage system of claim 1 further comprising at least two openings in the vertical lift module.

8. The vertical cold chain temperature-controlled storage system of claim 7 wherein the at least two openings in the vertical lift module enable a tote to be placed on or off the shelf from both directions.

9. The vertical cold chain temperature-controlled storage system of claim 1 wherein the vertical cold chain temperature-controlled storage system is in an ambient environment.

10. The vertical cold chain temperature-controlled storage system of claim 1 wherein the vertical lift module can rotate the plurality of shelves to align one or more of the plurality of shelves with the at least one opening.

11. A method of operating a vertical cold chain temperature-controlled storage system, comprising:
providing, via a power subsystem, power a tote on one or more of a plurality of shelves;
where the vertical cold chain temperature-controlled storage system comprises: a vertical lift module comprising:
a plurality of shelves; and
at least one opening.

12. The method of claim 11 wherein the power subsystem comprises power contacts at the bottom of the shelves.

13. The method of claim 11 wherein the power subsystem comprises a wireless power system.

14. The method of claim 11 wherein one or more of the plurality of shelves comprises a locking mechanism for securing a tote.

15. The method of claim 11 further comprising:
providing, via a communication module, communication with the vertical cold chain temperature-controlled storage system.

16. The method of claim 15 wherein providing communication enables control of on demand cooling for one or more of the plurality of shelves.

17. The method of claim 11 wherein the vertical lift module comprises at least two openings.

18. The method of claim 17 further comprising:
enabling a tote to be placed on or off the shelf from both directions.

19. The method of claim 11 wherein the vertical cold chain temperature-controlled storage system is in an ambient environment.

20. The method of claim 11 wherein the vertical lift module can rotate the plurality of shelves to align one or more of the plurality of shelves with the at least one opening.
